(19) United States
(12) Patent Application Publication
(10) Pub. No.: US 2017/0270786 A1
(43) Pub. Date: Sep. 21, 2017

(54) Integrated Vehicle-to-Vehicle/Vehicle-to-Infrastructure Communications Antenna in Light-Bar

(71) Applicant: Federal Signal Corporation, Oak Brook, IL (US)

(72) Inventors: Vishnu Swaminathan, Wilmette, IL (US); Scott Thomas Rohrbaugh, Clarendon Hills, IL (US)

(21) Appl. No.: 15/458,502

(22) Filed: Mar. 14, 2017

Related U.S. Application Data
(60) Provisional application No. 62/308,346, filed on Mar. 15, 2016.

(51) Int. Cl. G08G 1/0965; H04W 4/00; B60Q 1/46

(52) U.S. Cl. CPC G08G 1/0965; B60Q 1/46; H04W 4/008

(57) ABSTRACT

A light-bar can include at least one light beam assembly configured to provide emergency warning lights for an emergency vehicle. The light-bar can also include a Dedicated Short Range Communication (DSRC) antenna configured to communicate with other vehicles or infrastructure. The light beam assembly and the DSRC antenna are positioned within a housing of the light-bar

### BACKGROUND

Intersections are the locations responsible for the largest percentage of major accidents involving emergency vehicles. Most of the accidents are between emergency vehicles and civilian passenger cars, and some of them between multiple emergency vehicles. In most cases, the reason for the accident is the failure of the motorist to yield the right-of-way to an approaching emergency vehicle with audible and visual emergency signals in use. Further anecdotal evidence suggests that this failure to yield right-of-way is due to a general lack of situational awareness on the part of the civilian motorist. In cases where two emergency vehicles collide with each other, the collision is generally at an angle, implying that the two emergency vehicles were approaching in directions perpendicular to each other.

Typically, emergency vehicles use lights and sirens as warning devices to alert motorists of their approach. However, the effectiveness of lights and sirens has diminished with improvements in soundproofing of automobiles and drivers focused on more than just driving, such as loud radios, cell-phones and other hand-held devices drawing their attention away from the road.

Traffic preemption systems, such as Opticom and E-views, try to address this problem by giving the emergency vehicle the right-of-way. Unfortunately, these have not been widely deployed. Furthermore, such systems are not standardized and operate on proprietary protocols and frequency bands.

### SUMMARY

In one aspect, a light-bar includes: at least one light beam assembly configured to provide emergency warning lights for an emergency vehicle; and a Dedicated Short Range Communication (DSRC) antenna configured to communicate with other vehicles or infrastructure.

### DESCRIPTION OF THE FIGURES

FIG. 1 shows an example emergency vehicle including a light-bar.

FIG. 2 shows additional details of the example light-bar of FIG. 1.

### DETAILED DESCRIPTION

In examples described herein, a communications module is integrated into a light-bar positioned on an upper portion of an emergency vehicle. In example embodiments, the communications module is a Dedicated Short Range Communication (DSRC) antenna, although other configurations are possible.

In one embodiment, DSRC has the potential for decreasing accidents involving emergency vehicles. DSRC can be used to communicate between two or more vehicles to improve situational awareness (called Vehicle-to-Vehicle Communication or V2V communication) and/or between vehicles and infrastructure such as traffic signals to provide a traffic pre-emption method (called Vehicle-to-Infrastructure Communication or V2I communication). Thus, DSRC can significantly reduce intersection hazards to emergency vehicles by projecting the presence of emergency vehicles right to the interior of a passenger car.

DSRC typically operates in the 5.9 GHz radio-frequency range and therefore requires the use of an antenna. Since DSRC operates in the RF frequency band, it is a line-of-sight communication mechanism. In other words, the range of the DSRC transmitter is limited by how far the antenna can “see”. This means that raising the height of the antenna enables a greater transmission range. The location of the antenna is therefore important to the successful application of DSRC technology to prevent vehicular collisions.

In this disclosure, a V2V/V2I communications antenna (such as a DSRC antenna) is integrated into the light-bar of an emergency vehicle. Examples of light-bars are provided in U.S. Pat. Nos. 7,476,013 and 8,950,913. The antenna could be stand-alone and connected to other electronic systems using wires or wireless communication, or the antenna could be directly etched on a printed circuit board and connected to other electronic systems using traces on the printed circuit board, or a combination of both.

Such an antenna could enable vehicle-to-vehicle and vehicle-to-infrastructure communications in any subset or multiplicity of commonly-used digital RF communications bands, such as 2.4 GHz, 2.9 GHz, 5.9 GHz, unlicensed MHz bands, etc. and could be capable of supporting transmission and reception via FM, AM, satellite, two-way radio, radar, cellular, RFID, Bluetooth, Wi-Fi, ZigBee, GPS, and/or DSRC, as well as analog RF communications schemes. The antenna may be uni-directional, multi-directional, or omni-directional, and may take the form of a whip, a dipole, a multi-pole, a planar array, or a set of multiple antennas and types. The amplification and processing electronics to which the antenna(s) is (are) coupled may be located within the body of the light-bar or elsewhere on the emergency vehicle.

Non-limiting examples of such DSRC antennas include the DCP.5900.12.4.A.02 DSRC Ceramic Patch antenna or the TD.10 Triton 5 dBi DSRC 5.9 GHz Dipole Terminal antenna from Taoglas of San Diego, Calif. Another example is the MCA 2458 S Low Profile antenna from Hirschmann Car Communication GmbH of Germany. Other antennas can be used.

In some embodiments, a V2V and/or V2I optical digital communications transceiver can be integrated into the light-bar of an emergency vehicle. Such a transceiver would enable V2V and V2I communications in any subset of optical communications bands. The amplification and processing electronics to which the antenna(s) is(are) coupled may be located within the body of the light-bar or elsewhere on the emergency vehicle.

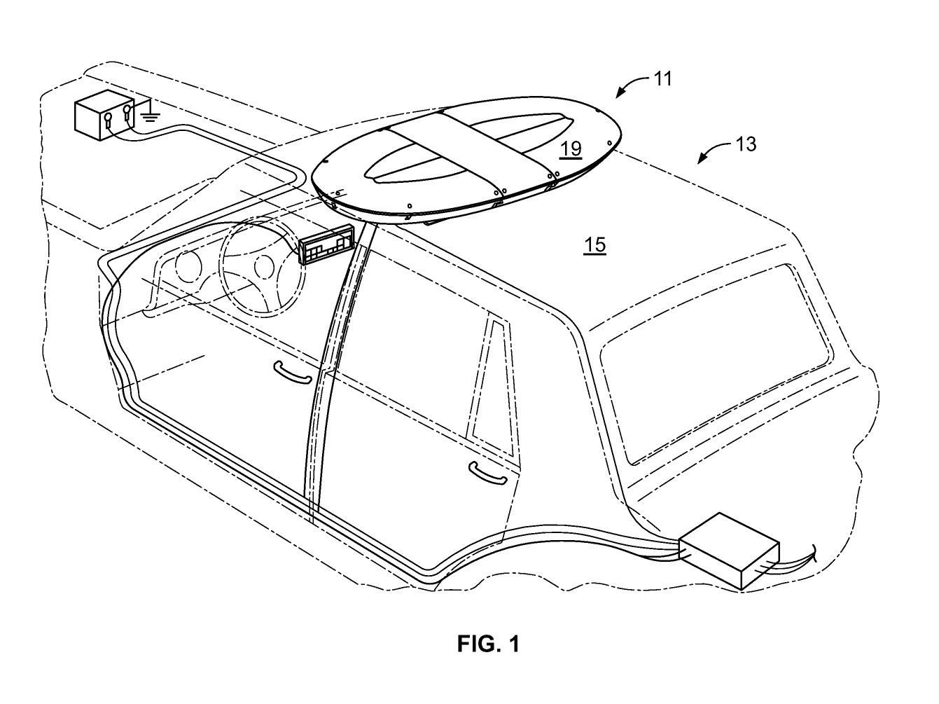

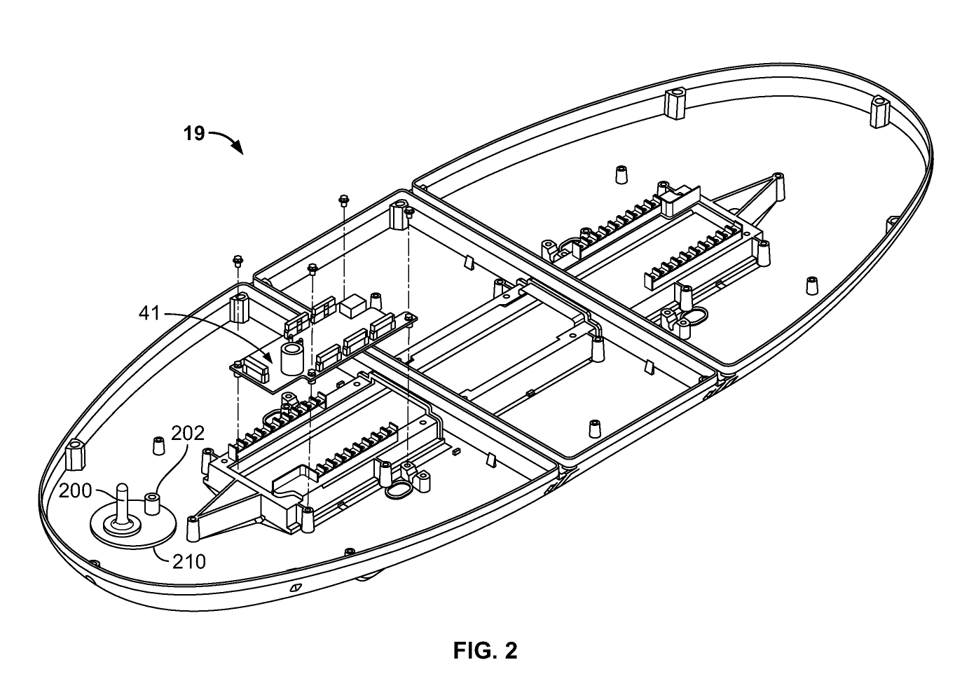

For example, referring now to FIGS. 1 and 2, an example light-bar 11 is shown installed on an exemplary emergency vehicle 13 shown in broken lines. The light-bar 11 is mounted to a roof 15 of the vehicle 13.

As shown more in FIG. 2, the light-bar 11 include a housing 19 that encloses circuitry and light beam assemblies that provide the emergency warning functionality. Positioned within the housing 19 of the light-bar 11 is a DSRC antenna 200 and accompanying optional controller 202. In this example, the DSRC antenna 200 and/or controller 202 is/are coupled to a circuit board 210 enclosed within the housing 19 so that the housing 19 protects the DSRC antenna 200.

As positioned within the light-bar 11 on the roof 15 of the vehicle 13, the DSRC antenna 200 has a greater line of sight with other vehicles and/or infrastructure having similar DSRC technology. In this manner, the DSRC antenna 200 functions more efficiently.

Further, incorporation of the DSRC antenna 200 into the light-bar 11 allows an emergency vehicle, such as the vehicle 13, to be outfitted with such technologies more easily and efficiently. Simply by incorporating the light-bar 11 onto the vehicle 13, the vehicle 13 can be enhanced with both the warning lights provided by the light beam assemblies within the light-bar 11 and DSRC functionality provided by the DSRC antenna 200 within the light-bar 11.

In some embodiments, the V2V/V2I antenna/controller can also be integrated into the light-bar controller 41 (see FIG. 2), configured to activate automatically with the activation of the light-bar or independently of the light-bar. In yet other examples, the V2V/V2I antenna/controller can be integrated into the optical signal emission head of covert lighting devices installed in the interior of marked and unmarked emergency vehicles.

When the light bar (or siren) is activated, the V2V/V2I controller 202 intercepts the activation signal and gathers relevant telemetry data, such as speed, heading, direction, acceleration, brake system status, etc., pertaining to the emergency vehicle 13. The controller 202 then converts this information into a format suitable for transmission. It then broadcasts this information via the antenna 200.

Since the light-bar is located on the roof of the emergency vehicle, it is the highest part of the vehicle, and placement of the DSRC antenna within or upon the light-bar structure may allow for the greatest range for the transmitter. In addition, the light-bar would also provide a safe, weatherproof and secure housing for the antenna. A DSRC transmitter located in the emergency vehicle with the antenna in the light-bar would then enhance the broadcast range of its signal over the greatest possible distance. This signal could be picked up by a DSRC or other types of receivers located on the road-side by the traffic light to allow traffic preemption. The signal could also be picked up by receivers located in emergency vehicles or passenger cars to alert the drivers of the presence of the nearby emergency vehicle.

What is claimed is:

1. A light-bar, comprising:
at least one light beam assembly configured to provide emergency warning lights for an emergency vehicle; and
a Dedicated Short Range Communication (DSRC) antenna configured to communicate with other vehicles or infrastructure.

2. The light-bar of claim 1, wherein the at least one light beam assembly and the DSRC antenna are positioned within a housing of the light-bar.

3. The light-bar of claim 1, wherein the DSRC antenna is configured to emit a signal to provide traffic preemption.

4. The light-bar of claim 1, wherein the DSRC antenna is configured to emit a signal capable of being received by other vehicles to alert the drivers of a presence of the emergency vehicle.

5. The light-bar of claim 1, wherein the DSRC antenna is configured to:
emit a first signal to provide traffic preemption; and
emit a second signal capable of being received by other vehicles to alert the drivers of a presence of the emergency vehicle

6. An emergency vehicle, comprising:
a light-bar including at least one light beam assembly configured to provide emergency warning lights for an emergency vehicle, and a Dedicated Short Range Communication (DSRC) antenna configured to communicate with other vehicles or infrastructure.

7. The emergency vehicle of claim 6, wherein the at least one light beam assembly and the DSRC antenna are positioned within a housing of the light-bar.

8. The emergency vehicle of claim 6, wherein the DSRC antenna is configured to emit a signal to provide traffic preemption.

9. The emergency vehicle of claim 6, wherein the DSRC antenna is configured to emit a signal capable of being received by other vehicles to alert the drivers of a presence of the emergency vehicle.

10. The emergency vehicle of claim 6, wherein the DSRC antenna is configured to:
emit a first signal to provide traffic preemption; and
emit a second signal capable of being received by other vehicles to alert the drivers of a presence of the emergency vehicle

11. A method for providing signaling for an emergency vehicle, comprising:
providing a light-bar including at least one light beam assembly configured to provide emergency warning lights for an emergency vehicle; and
positioning within the light-bar a Dedicated Short Range Communication (DSRC) antenna configured to communicate with other vehicles or infrastructure.

12. The method of claim 11, further comprising positioning the at least one light beam assembly and the DSRC antenna within a housing of the light-bar.

13. The method of claim 11, further comprising allowing the DSRC antenna to emit a signal to provide traffic preemption.

14. The method of claim 11, further comprising allowing the DSRC antenna to emit a signal capable of being received by other vehicles to alert the drivers of a presence of the emergency vehicle.

15. The method of claim 11, further comprising allowing the DSRC antenna to:
emit a first signal to provide traffic preemption; and
emit a second signal capable of being received by other vehicles to alert the drivers of a presence of the emergency vehicle
